(19) United States
(12) Patent Application Publication
(10) Pub. No.: US 2015/0068980 A1
(43) Pub. Date: Mar. 12, 2015

(54) NANOCOMPOSITE FOR REMOVING SELENIUM FROM WATER

(71) Applicant: KING FAHD UNIVERSITY OF PETROLEUM AND MINERALS, DHAHRAN (SA)

(72) Inventors: OMER YAHYA BAKATHER, DHAHRAN (SA); MUATAZ ALI ATIEH, DHAHRAN (SA)

(73) Assignee: KING FAHD UNIVERSITY OF PETROLEUM AND MINERALS, DHAHRAN (SA)

(21) Appl. No.: 14/025,775

(22) Filed: Sep. 12, 2013

(51) Int. Cl. C02F 1/28; B01J 20/20; B01J 20/32

(52) U.S. Cl. CPC C02F 1/288; B01J 20/3295; B01J 20/205; B82Y 30/00
USPC 210/663; 210/660; 252/178; 977/778; 977/902; 977/896

(57) ABSTRACT

The nanocomposite for removing selenium from water is multi-walled carbon nanotubes impregnated with iron. The nanocomposite is made by dissolving iron nitrate in ethanol, adding the carbon nanotubes, heating the mixture to evaporate the ethanol, and calcining the resulting nanocomposite. The carbon nanotubes preferably have a length and a diameter between 10 nm and 30 nm, and the iron is homogenously distributed in the nanotubes as nanoparticles of 1-2 nm diameter. The nanocomposite adsorbs selenium from aqueous solution. The pH of the aqueous solution may be adjusted to between 1 and 4, adsorption being most efficient at a pH of 1.

### BACKGROUND OF THE INVENTION

1. Field of the Invention

The present invention relates to water purification compositions and processes, and particularly to a nanocomposite for removing selenium from water that is made from carbon nanotubes impregnated with iron.

2. Description of the Related Art

Selenium is an essential nutrient for the growth and good health of animals and humans in trace concentrations. It is toxic at high concentrations. Therefore, selenium intake must not exceed 1 mg/Kg of body weight. Selenium exists naturally in the environment in trace amounts in four oxidation states, including elemental selenium (Se(0)), selenide ion (Se (-II)), selenite ion (Se(IV), and selenate ion (Se(VI)). It can also be found in organic compounds, such as amino acids or methylated compounds. The main sources of selenium in the environment are weathering of natural rock, anthropogenic activities, and various industrial and manufacturing operations. Selenium is used in the manufacture of pigmented glass, stainless steel, electronic components (semiconductors, photoelectric cells), explosives, lubricants, rubber, ceramic, rectifiers, batteries, shampoos, animal and poultry feeds, photocells, fungicides, etc. Different techniques have been investigated to remove selenium from water, such as reverse osmosis, precipitation, membranes, ion exchange, emulsion liquid membranes, nanofiltration, reduction, Lactuca sativa L. plants, TiO₂ photocatalyst, and adsorbents (such as activated carbon, alumina, iron oxides, coated iron sand, manganese greensand, peat impregnated with ferric oxyhydroxide, lanthanum oxide or lanthanum oxide/alumina substrates), etc.

Carbon nanotubes (CNTs) have attracted considerable research interest due to their extraordinary mechanical electrical properties, high chemical stability, and large specific area. They have unique characteristics that make them potentially useful in many applications in nanotechnology, optics, electronics, water treatment, and other fields of materials science. Multiwalled carbon nanotubes (MWCNT) have been previously used for removal of metal ions, such as lead, copper, cadmium, silver, and nickel.

Thus, a nanocomposite for removing selenium from water solving the aforementioned problems is desired.

### SUMMARY OF THE INVENTION

The nanocomposite for removing selenium from water is multi-walled carbon nanotubes impregnated with iron. The nanocomposite is made by dissolving iron nitrate in ethanol, adding the carbon nanotubes, heating the mixture to evaporate the ethanol, and calcining the resulting nanocomposite. The carbon nanotubes preferably have a length and a diameter between 10 nm and 30 nm, and the iron is homogenously distributed in the nanotubes as nanoparticles of 1-2 nm diameter. The nanocomposite adsorbs selenium from aqueous solution. The pH of the aqueous solution may be adjusted to between 1 and 4, adsorption being most efficient at a pH of 1.

These and other features of the present invention will become readily apparent upon further review of the following specification and drawings.

### BRIEF DESCRIPTION OF THE D WINGS

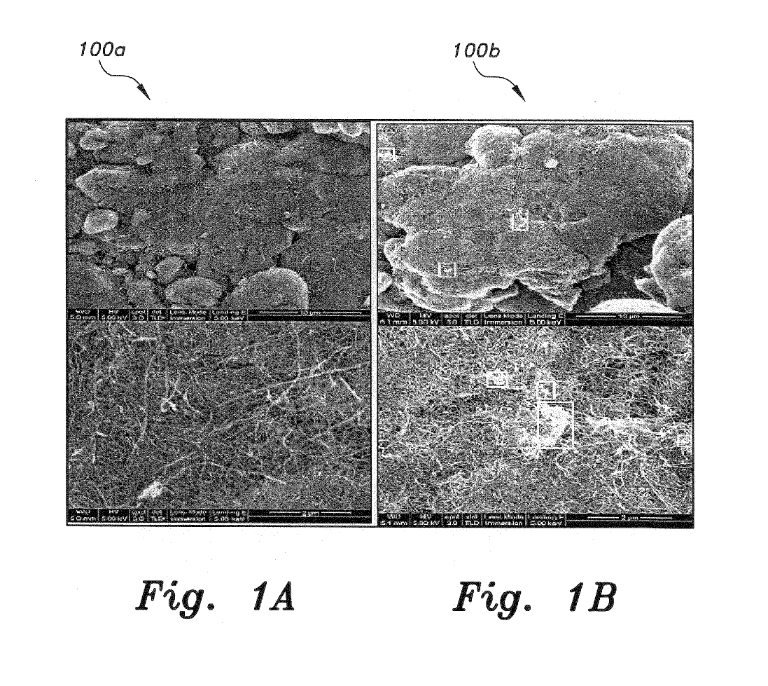

FIG. 1A are SEM images of raw MWCNTs, shown under high magnification (the upper image) and low magnification (the lower image).

FIG. 1B are SEM images of nanocomposites for removing selenium from water according to the present invention, shown under high magnification (the upper image) and low magnification (the lower image).

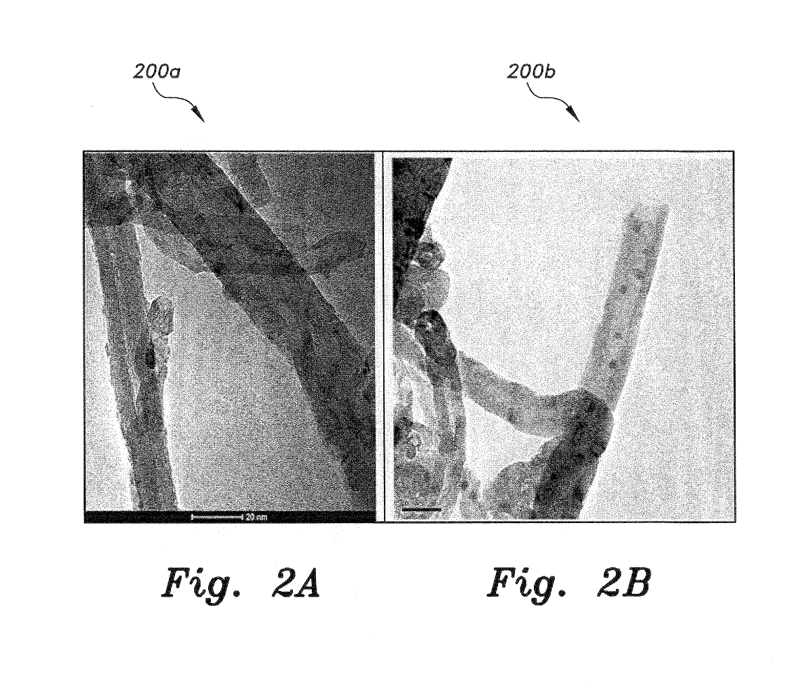

FIG. 2A is a TEM image of raw MWCNTs.

FIG. 2B is a TEM image of nanocomposites for removing selenium from water according to the present invention.

FIG. 3 is a plot of the effect of pH on percentage removal of selenium for the nanocomposite for removing selenium from water according to the present invention.

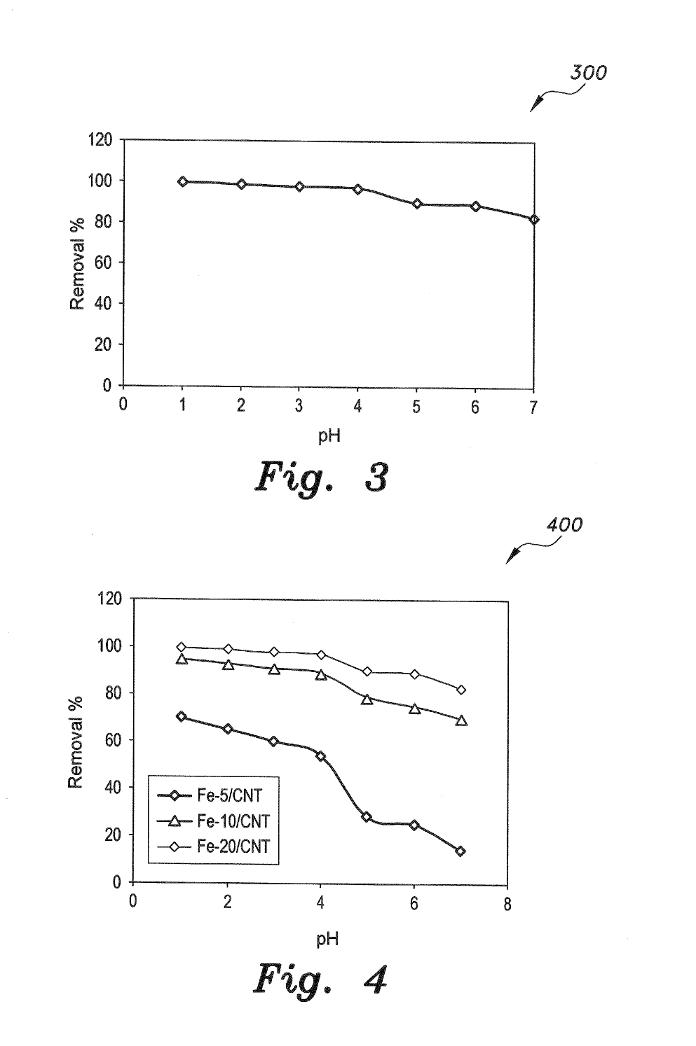

FIG. 4 is a plot showing the effect of the concentration of iron on percentage removal of selenium for the nanocomposite for removing selenium from water according to the present invention.

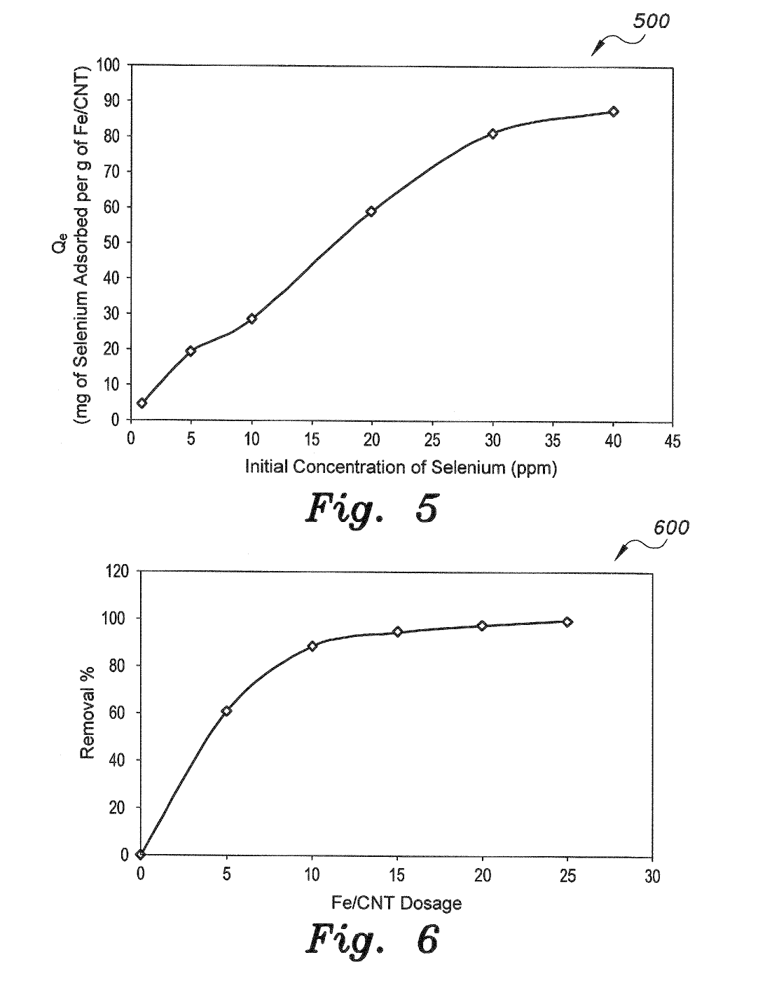

FIG. 5 is a plot of the effect of the initial concentration of selenium on the adsorption capacity of the nanocomposite for removing selenium from water according to the present invention.

FIG. 6 is a plot showing the effect the concentration of the nanocomposite on selenium removal for the nanocomposite for removing selenium from water according to the present invention.

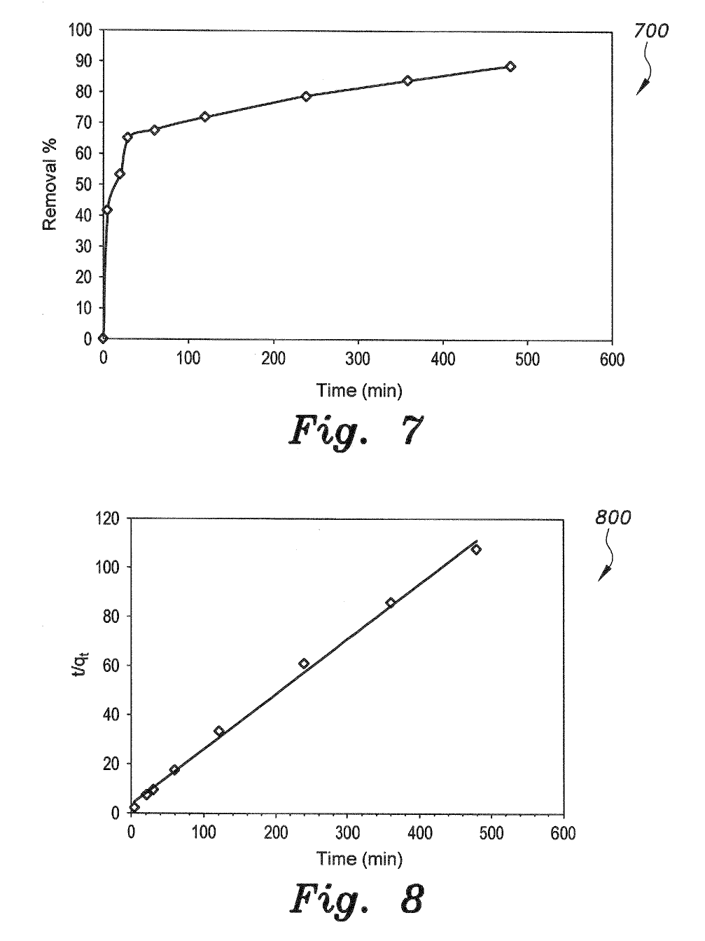

FIG. 7 is a plot of the effect of contact time on selenium removal for the nanocomposite for removing selenium from water according to the present invention.

FIG. 8 is a plot of the pseudo second-order kinetics of selenium according to the present invention.

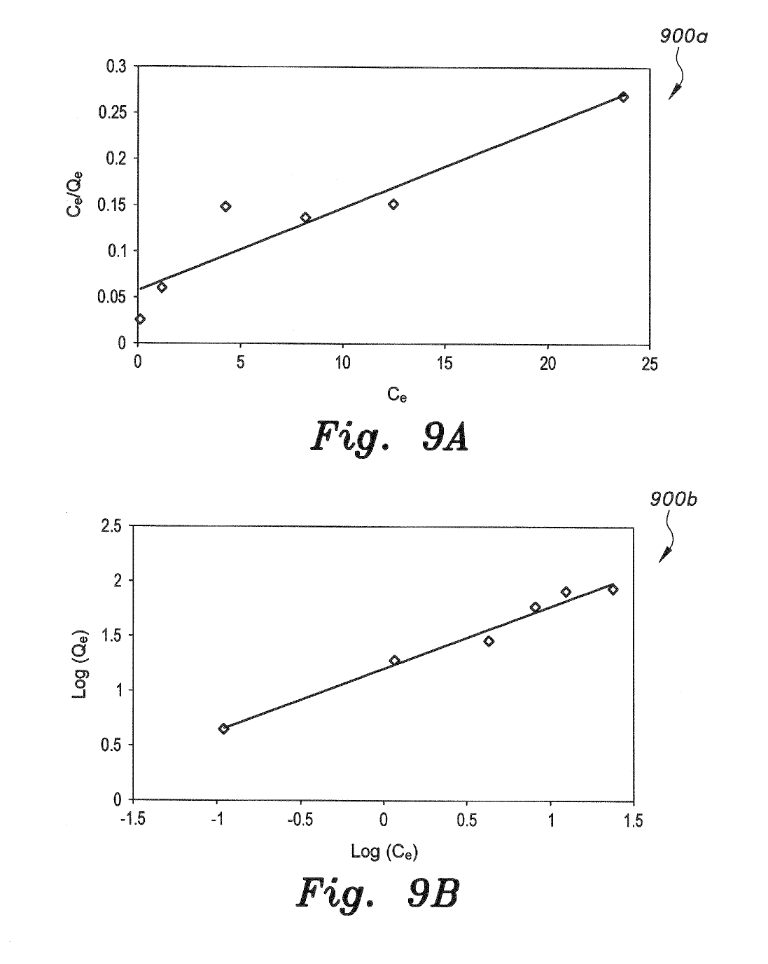

FIG. 9A is a plot of the Langmuir adsorption isotherm model of selenium.

FIG. 9B is a plot of the Freundlich adsorption isotherm model of selenium.

Similar reference characters denote corresponding features consistently throughout the attached drawings.

### DETAILED DESCRIPTION OF THE PREFERRED EMBODIMENTS

The nanocomposite for removing selenium from water is fabricated by impregnating multiwalled carbon nanotubes (MWCNTs) with iron. The iron-impregnated carbon nanotubes (FE/CNTs) possess an improved capacity to remove selenium from water.

The nanocomposite is synthesized as follows. About 1.8 grams of iron (III) nitrate is dissolved in 200 ml of ethanol solution and mixed with 4.75 grams of multiwalled carbon nanotubes (MWCNTs) to prepare the carbon nanotubes for impregnation by iron nanoparticles with 5 wt % iron. The solution is mixed using an ultrasonic mixer for 30 minutes. Then, the solution is put into a beaker and placed in a furnace at 60-80° Centigrade overnight to evaporate the ethanol. Finally, to provide calcination, the product is placed in an oven at 350° C. for 3 hours. The same process can be followed to produce MWCNTs impregnated with iron nanoparticles with 10 wt % and 20 wt % iron.

A stock solution of aqueous selenium is prepared by dissolving the proper amount of SeO₂ in deionized water, depending on the required concentration. The pH of the stock solution is adjusted by using 0.1 M Nitric Acid or 0.1 M NaOH. Finally, buffer solutions are added to maintain the pH constant during the experiment.

The experiments of the batch mode adsorption were carried out at room temperature using a volume of 50 ml selenium solution in each run and put in volumetric flasks to investigate the effect of pH of solution, contact time, CNTs dosage, and initial concentration of Se ions on the adsorption of selenium ions. The flasks were covered and mounted on a mechanical rotary shaker (MPI Lab Shaker) and shaken. The initial and final concentrations of selenium ions were analyzed by using Inductively Coupled Plasma (ICP).

The study of sorption kinetics is used to express the adsorbate uptake rate as function of the residence time of adsorbate at the solid/liquid interface. The pseudo-second-order rate equation is expressed as:

$$\frac{t}{{q}_{t}} = \frac{1}{{K}_{2} {q}_{e}^{2}} + \frac{t}{{q}_{e}} \qquad ( 1 )$$

where qₑ is sorption capacity (mg/g) at equilibrium, qₜ is sorption capacity (mg/g) at time t, t is time (min), and K₂ is the rate constant of the pseudo-second-order sorption (g·mg⁻¹·min⁻¹).

Adsorption isotherm models are used to describe the distribution of the adsorbate species between liquid and adsorbent. The Langmuir and Freundlich isotherms were used to study the adsorption performance and to calculate the adsorption capacity for the adsorbent. The Langmuir adsorption isotherm is expressed as:

$${Q}_{e} = \frac{{q}_{{mK}_{L}} {C}_{e}}{1 + {K}_{L} {C}_{e}} \qquad ( 2 )$$

where Qₑ is the amount adsorbed (mg/g), Cₑ is the equilibrium adsorbate concentration (mg/l), K_{L} is the Langmuir constant, and qₘ is the maximum adsorption capacity (mg of adsorbate adsorbed per g of adsorbent). Equation (1) can be linearized as follows:

$$\frac{{C}_{e}}{{Q}_{e}} = \frac{{C}_{e}}{{q}_{m}} + \frac{1}{{K}_{L} {q}_{m}} \qquad ( 3 )$$

The Freundlich isotherm is expressed as:

Qₑ=K_{f}Cₑ^{1/n} (4)

Equation (3) can be linearized as follows:

$$log {Q}_{e} = \frac{1}{n} log {C}_{e} + log {K}_{f} \qquad ( 5 )$$

where: K_{f} and n are the empirical constants that depend on several environmental factors.

The raw MWCNTs and impregnated MWCNTs (Fe/CNT) were also characterized using SEM and TEM techniques. The morphologies of these samples were obtained by SEM. FIG. 1A are SEM images 100a of raw MWCNTs, shown under high magnification (the upper image) and low magnification (the lower image). FIG. 1B are SEM images 100b of MWCNTs impregnated with iron as described above, shown under high magnification (the upper image) and low magnification (the lower image). The SEM images of FIG. 1B show that the Fe/CNT sample has metal clusters of iron composites. These iron composites are box highlighted in FIG. 1B. Energy dispersive spectroscopy (EDS) analysis was carried out in an attempt to semi-quantitatively identify the elemental contents of the Fe/CNTs, especially for trace amounts of metals and catalysts. The analysis confirmed the percentage of impregnating.

FIG. 2A shows the High Resolution Transmission Electron Microscope (HRTEM) images 200a of raw carbon nanotubes. It is a highly ordered crystalline structure of Multi-Walled Carbon Nanotubes (MWCNTs) with diameter ranging from 10-30 nm and length from 10-30 (μm). FIG. 2B shows the TEM images 200b of MWCNTs impregnated with iron nanoparticles via wet impregnation methods. The diameter of the Fe nanoparticles ranges from 1-2 nm with spherical shape and homogenous distribution.

The pH of the solution is an important factor that controls the adsorption of selenium ions on the adsorbent surface. When the pH of the solution is lower than the pH_{PZC} (Point of Zero Charge), the positive charge on the surface provides electrostatic interactions that are favorable for adsorbing anionic species.

The adsorption of selenium species was increased with the decrease of pH, and the optimum pH for adsorption of selenium was 1-4, where the selenium was completely removed at pH 1 (shown in plot 300 of FIG. 3) because the positive charge of the adsorbent surface increases the electrical attraction between the surface and the selenium species, which increases the possibility of surface complexation of selenium. Adsorption was decreased slightly when the pH of the solution was increased, this being due to an increase of the negative charge of the adsorbent surface and an increase of the competition of OH⁻ and selenium ions on the site of the adsorbent.

The pure CNTs showed poor adsorption of selenium (about less than 1% at pH of 1 and 2 and zero removal at higher than pH 2). However, the iron (Fe) impregnated CNTs exhibited tremendously improved selenium removal, as shown in plot 400 of FIG. 4. Increasing the percentage of Fe impregnation caused an increase in the adsorption of selenium. Increasing the adsorption of the selenium using impregnated Fe/CNT contributed to an increase in the positive charge of the CNTs surface. The impregnation by the Fe resulted in an increase of pH_{PZC} (Point of Zero Charge) of the CNTs surface, thereby enhancing the electrostatic interactions between the selenium species and the surface of the CNTs. CNTs impregnated with 20 wt % of Fe (Fe-20/CNTs) were selected to study the effects of initial concentration, Fe-20/CNTs dosage, contact time, kinetics and isotherms models.

Increasing the initial concentration of selenium caused the adsorption capacity of Fe-20/CNT to increase. This is due to increasing the driving force of mass transfer of selenium ions towards the Fe-20/CNTs surfaces. The highest adsorption capacity was about 88 mg/g using an initial selenium concentration of 40 ppm, as shown in plot 500 of FIG. 5.

The batch adsorption experiments were carried out by using various amounts of Fe-20/CNTs (varying from 5 to 25 mg), while the pH, contact time, and agitation speed were fixed at 6, 6 hours, and 150 rpm respectively, as shown in plot 600 of FIG. 6. Adsorption of selenium ions increased correspondingly with an increasing dosage of Fe-20/CNTs. This was due to an increase in the adsorption sites on the Fe-20/CNTs surfaces. Selenium ions were completely removed from the solution by using only 25 mg of Fe-20/CNTs.

The experiments showed that the adsorption of selenium was rapid during the first 30 minutes, reaching about 65% removal. Then, the adsorption was increased slightly to reach the maximum removal of selenium within four hours, as shown in plot 700 of FIG. 7.

The study showed that adsorption of selenium was well described by a pseudo second-order rate. The plot of t/Qₜ versus time (t) (plot 800 of FIG. 8) yields very good straight lines (R²=0.996). The second-order rate constant (K₂) obtained from this is 0.787 (g·mg⁻¹·h⁻¹).

Langmuir and Freundlich models were modeled as shown in plots 900a and 900b of FIGS. 9A and 9B, respectively. The Freundlich adsorption isotherm showed good agreement with the experimental data with the correlation coefficient value (R²) of 0.98, as compared to the Langmuir adsorption isotherm with the correlation coefficient value (R²) of 0.879. The higher correlation coefficient value (R²) of the Freundlich adsorption isotherm suggests forming multilayers of adsorbate (selenium ions) on the Fe-20/CNT surface.

Table 1 shows parameters of the Langmuir and Freundlich adsorption isotherm models of selenium. The maximum adsorption capacity of Fe/CNT is 111 (mg/g). Therefore, it was verified that Fe-20/CNTs have great potential to be an excellent adsorbent for the removal of selenium ions in water treatment.

| Langmuir | | | Freundlich | | |
|---|---|---|---|---|---|
| qₘ | K_{L} | | | K_{F} | |
| (mg/g) | (Lmg⁻¹) | R² | n | (mg^{(1-1/n)}L^{1/n}g⁻¹) | R² |
| 111 | 0.158 | 0.879 | 1.74 | 16 | 0.98 |

It is to be understood that the present invention is not limited to the embodiments described above, but encompasses any and all embodiments within the scope of the following claims.

We claim:

1. A process for making a nanocomposite for removing selenium from water, comprising the steps of:
(a) dissolving iron (III) nitrate in ethanol;
(b) ultrasonically mixing multi-walled carbon nanotubes (MWCNTs) in the solution of step (a);
(c) heating the ultrasonically mixed solution of step (b) in a furnace at a temperature of between 60° C. and 80° C. for a time period sufficient to evaporate the ethanol, leaving the nanocomposite; and
(d) calcining the nanocomposite in an oven at 350° C. for 3 hours.

2. A method for removing selenium from water, comprising the step of placing multi-walled carbon nanotubes impregnated with iron into contact with the water to adsorb the selenium.

3. The method for removing selenium from water according to claim 2, further comprising the step of adjusting the pH of the water to between 1 and 4.

4. The method for removing selenium from water according to claim 2, further comprising the step of adjusting the pH of the water to 1.

5. The method for removing selenium from water according to claim 2, wherein the multi-walled carbon nanotubes impregnated with iron comprises about 20 wt % iron.

6. The method for removing selenium from water according to claim 2, wherein the multi-walled carbon nanotubes in the multi-walled carbon nanotubes impregnated with iron have a diameter between 10 nm and 30 nm, and a length between 10 nm and 30 nm.

7. The method for removing selenium from water according to claim 6, wherein the iron in the multi-walled carbon nanotubes impregnated with iron comprises nanoparticles having a diameter of 1-2 nm homogenously distributed in the multi-walled carbon nanotubes.
